(19) United States
(12) Patent Application Publication
(10) Pub. No.: US 2021/0385426 A1
(43) Pub. Date: Dec. 9, 2021

(54) A CALIBRATION METHOD FOR A RECORDING DEVICE AND A METHOD FOR AN AUTOMATIC SETUP OF A MULTI-CAMERA SYSTEM

(71) Applicant: ADVERTIMA AG, St. Gallen (CH)

(72) Inventors: Simon EBNER, St. Gallen (CH); Nebojsa ANDELKOVIC, St. Gallen (CH); Fang-Lin HE, St. Gallen (CH); Martin AFFOLTER, St. Gallen (CH); Vuk ILIC, St. Gallen (CH); Mohammad Seyed ALIVI, I, Zürich (CH)

(21) Appl. No.: 17/286,165

(22) PCT Filed: Oct. 16, 2018
(86) PCT No.: PCT/EP2018/078142

§ 371 Date: Apr. 16, 2021

(51) Int. Cl. H04N 13/246; G06T 7/80; G06K 9/00

(52) U.S. Cl. CPC H04N 13/246; G06T 7/85; H04N 2013/0074; G06K 9/00677; G06K 9/00771

(57) ABSTRACT

A calibration method (1) for a recording device (2). The method includes receiving, with a data interface (11) of a data processing system (3), a first data set (21) with an image and three dimensional information generated by the recording device (2). At least one person (4), within a field of view (8) of the recording device (2), is detected with an object detection component (12). Two or more attributes (5), of the person (4), are determined by an attribute assignment component (13). The attributes include an interest factor for an object and a location of the person (4). A descriptor (9) is generated based on the determined attributes (5). The data processing system calculates an attention model with a discretized space within the field of view based on the descriptor(s). The attention model is configured to predict a probability of a person showing interest for the object.

A calibration method for a recording device and a method for an automatic setup of a multi-camera system

The invention relates to the technical field of camera systems, which are adapted to track persons or objects that cross a field of view of the camera.

In a first aspect, the present invention relates to a calibration method for a recording device. In another aspect, the invention relates to a computer program product, a computer readable medium and a system for calibrating a recording device.

In a second aspect, the invention relates to a method for an automatic setup of a multi-camera system and a computer program product, a computer readable medium and a system for an automatic setup of a multi-camera system.

In public spaces such as in shopping centers retail stores, gas stations, train stations, airports, monitors are set up as informational hubs for providing relevant information such as directions, maps, agendas or advertisements. Similarly such monitors are also used in closed areas such as office buildings. The monitors may comprise an input device like a visual sensor. The data from the sensor is used to detect users, analyze the users and automatically show content based on the users without explicit further user input. One example may be a monitor showing directions to an optometrist to a wearer of glasses. In another example the monitor may allow an interaction, i.e. actively inviting a couple to a romantic restaurant, and upon an input displaying dishes or a menu.

When setting up the monitor, the engineer needs to set up the monitor and set up a camera system for recording the audience in front of the monitor. The camera systems face the problem that their field of view comprises areas, in which either the audience is not interested in the monitor or cannot observe the monitor in a reliable way. As a result, the monitor may display content to or interact with uninterested users. Further, the analysis of the camera images or videos requires a large amount of processing power. Thus, the analysis is often made on a cloud computing platform.

One technique to address this is the use of cameras with a limited field of view. These cameras are only directed to an area in which it is known that users are interested in the monitor. However, this requires a trained technical person to adapt the camera position manually during the installation. Further, if the interest area changes, e.g. due to construction work, the camera or the entire monitor with the camera has to be repositioned by the trained technical person as well.

U.S. Pat. No. 9,934,447 discloses object detection across disparate fields of view. A first image is generated by a first recording device with a first field of view. A second image is generated by a second recording device with a second field of view. An object classification component determines first and second level classifications of a first object in the first field a view. Then, a data processing system correlates the first object with a second object detected in the second field of view. While the U.S. Pat. No. 9,934,447 allows a certain recognition of objects in disparate fields of view, it does not provide assistance in setting up and maintaining a recording device.

EP 3 178 052 discloses a process for monitoring an audience in a targeted region. In the process, an image of a person located in the targeted region is captured and that image is analyzed by determining information about the person. Consequently a database of the audience is created and the human is registered in the database with human attributes. According to EP 3 178 052, the person is provided with an exclusion mark for monitoring the person. The document does not allow a calibration of a recording device.

EP 3 105 730 relates to a method performed by a system for distributing digital advertisements by supplying a creative for a campaign. The method includes the steps of determining criteria for the campaign comprising targeting a demographic group and selecting one or more digital boards based on static data, projected data and real-time data. The method generates an ongoing report for the advertising campaign to enable adjustment of the creative in real-time during the advertising campaign.

The present invention aims to provide a method that simplifies the technical set-up of the camera system and allows in particular shorter installation times and, optionally, a flexible and adaptive system. In one aspect the problem of the invention is to overcome the disadvantages of the prior art.

According to the first aspect of the invention, a calibration method for a recording device is provided. The method includes the step of receiving, with a data interface of a data processing hardware system, a first data set. The data set comprises an image and a three dimensional information, in particular a three dimensional scene. The data set may be generated by a recording device at a first time. The recording device has a field of view. At least one person within the field of view of the recording device is detected in the first data set with an object detection component of the data processing hardware system. Two or more attributes of the at least one person from the first data set are determined by an attribute assignment component of the data processing hardware system. The attributes include an interest factor for an object and a three dimensional location of the at least one person. The object may or may not be within the field of view of the recording device. Based on at least the determined attributes of the at least one person a descriptor is generated with the data processing hardware system. The data processing hardware system calculates an attention model with a discretized space within the field of view based on the descriptors. The attention model is configured to predict a probability of a person showing interest for the object.

As used herein “three dimensional information” is to be understood as three dimensional spatial information. The three dimensional information relates to the spatial coordinates of an object in the field of view of the camera.

In one embodiment, the interest factor may be calculated as follows: The interest factor may be a ratio of people that passes through an area and express an interest divided by a total number of people that passes through an area.

In an embodiment, an interest area may be calculated with the data processing hardware system based on the attention model. The interest area may be a distinct area, outside of which persons are not considered for the calibration of the recording device. The interest area may be calculated with a threshold. Users in discretized spaces where the interest factor is below the threshold are not considered. The threshold may be an absolute value (e.g. 30%) or a relative value (e.g. interest area is defined by quantiles). In one particular embodiment the interest area may be defined as surpassing a certain, in particular predefined, ratio of people that passes it with expressed interest to a total of number of people that area.

This allows a very simple and fast set up. There is no mechanical adjustment of the camera needed. If the attention model needs to be recalibrated, the method may be repeated at a later given time. A further advantage is that the method does not require on-site human attention but can be executed by a human off-site or be recalibrated by an automated software code.

Further the attention model determines that certain persons are less relevant. The attributes of these persons need not be analyzed as thoroughly which saves computing power. This may allow data processing hardware systems with less computing power and/or with a smaller size factors and aids in implementing compact data processing hardware systems directly next to or in the housing of the camera/monitor.

The method may be used to determine the interest of persons in an advertisement, e.g. played on a monitor. Further applications are ambiental intelligence and crowd management. The attention model may allow setting sounds and controlling lighting devices. The attention model may further allow an efficient crowd management by displaying directions or instructions for the detected persons on a display. This allows an optimized people flow and transportation. In particular embodiments, the attention model may be self-learning such that the ambiental intelligence and/or the crowd management is continuously and independently improving.

The method may also be used to improve surveillance, where the object might be relevant for the security of a building (e.g. detect persons interested in the controls of an automatic door).

Further the method may allow an analysis, which objects are of particular interest in the field of view. Upon such an analysis, work places, shops, or public spaces may be reorganized in order to optimize these spaces. For example, warning signs that are poorly placed could be identified and relocated. Another application could be a simplification of workflow. In a workflow, where a security agent has to check a number of objects, the method may detect whether a certain object was reviewed by the agent.

The recording device may include a stereo camera or infrared camera adapted to obtain three dimensional information, in particular three dimensional cloud points. The three dimensional information may be a plurality of three dimensional cloud points in the field of view of the recording device. The three dimensional scene may be obtained by multiple view geometry algorithms.

The person may or may not move. The object might be located in the field of view or outside the field of view. In an alternative embodiment, the object may be another person. The data generated by the recording device may be transmitted directly to the data interface. Alternatively the data may be processed by an intermediary (e.g. by a filter), before transmittal to the interface.

In one embodiment, the object detection component comprises an inclination sensor for the head pose of the at least one person. The inclination sensor may be realized as part of the object detection component.

The data interface may receive second, third and fourth data sets. In particular, the data interface may receive a continueously data sets frames (e.g. a video stream). three dimensional cloud points may be obtained for example with a stereo camera or infrared camera. The object detection component may be configured to detect static and/or dynamic persons.

The attention model may be a probabilistic model that is continuously updated based on the determined interest factors. The probabilistic model may be altered dependent on a time of day, the current day or based on personal attributes.

The cloud points are to be understood as a plurality of individual points with three dimensional coordinates.

In a preferred embodiment, the data interface of the data processing hardware system receives a further data set with an image and three dimensional information, in particular three dimensional cloud points, generated by the recording device at a second time. The second time is in particular after the first time. The object detection component of the data processing hardware system detects in the second data set at least one person within the field of view. The attribute assignment component of the data processing hardware system determines two or more attributes of the at least one person. The attributes include an interest factor for an object, for example a monitor, and a three dimensional location of the at least one person. The data processing hardware system generates a further descriptor based at least on the determined attributes of the at least one person. The data processing hardware system updates the attention model within the field of view based on the further descriptor.

Thereby, the attention model is updated based on additional data.

Further, the object detection component may comprise a speed sensor. The speed sensor may determine from the first and the second data set, a speed of the at least one person. The speed sensor may be realized as an algorithm on the data processing system. The speed sensor allows a better determination of the attention model, since a fast-moving person is less likely to be interested in the object.

Particularly preferred, the data interface receives a set of video frames with three dimensional cloud points. The data interface may receive a continuous stream of video frames and may continuously detect persons and update the attention model within the field of view continuously.

In a preferred embodiment, the object is a monitor and/or an audio device and method additionally comprises the following further steps. The attribute assignment component determines at least one further attribute. The data processing hardware system sends instructions to the monitor to play content based on the at least one further attribute and based on the attention model.

The content is in particular audio and/or video-based content.

Thereby, content is chosen based upon the preferences of the users in front of the monitor in the, who are actually engaged and interested in the monitor at the relevant time. The users currently interested in the monitor are usually not identical to the predicted users.

In a preferred embodiment, the at least one further attribute includes at least one of : age, gender, body , height, clothing, posture, social group, face attributes such as eyeglasses, hats, facial expressions, in particular emotions, hair color, beard or mustache. The attributes may be stored in anonymized form in the descriptor. These attributes are particularly advantageous as they allow choosing relevant content for the persons in the field of view.

In a preferred embodiment, the data interface of the data processing hardware system receives a further data set with images and three dimensional information, in particular three dimensional cloud points, generated by the recording device at a later time after the first time. The object detection component of the data processing hardware system detects in the second data set at least one person. Movement data is provided by at least one of: a movement tracker component of the data processing hardware system determines a movement of the at least one person in between the two data sets and/or the attribute assignment component determines an orientation of the body of the at least one person. The data processing hardware system determines a future location of the at least one person based on a motion model, wherein the motion model is updated based on the provided movement data. Additionally though not necessarily, the head pose may be used for the walking path prediction.

Thereby, the data processing hardware system is able to calculate a future position of the at least one person. As a result, the system is able to determine which persons will be located at a future time in which part of the discretized space of the attention model. This allows a more precise calculation of the future interest in the object.

The motion model may include information about a behavior of other people in the surrounding. Thereby the motion model may predict possible collisions between persons and recalculate the estimation of their walking path.

In a preferred embodiment, a database is provided to the data processing hardware system. The database may include past movements of persons through the field of view. The motion model is updated based on the past movements by the data processing hardware system. The data processing hardware system determines a future location of the at least one person based on the updated motion model. The motion model may comprise a probabilistic model of previous movements.

The data processing hardware system may provide thereby a more accurate prediction of the persons which are going to be located within the field of view. In particular this may allow predicting which persons are likely to be interest in the object or leave the field of view. The prediction is in particular based on the future location and the discretized space in the attention model. The database may comprise a discretized historical trajectory data.

In a preferred embodiment, the attribute assignment component determines at least one further attribute. The data processing hardware system sends instructions to the monitor to play content based on the at least one further attribute only of the persons whose future location was determined to be located in the field of view.

Thereby, the data processing hardware system allows a selection of the content based on the future audience. This may be used to play suitable advertisements according to the persons likely to pay attention and located within the field of view. This may further save computing resources.

In a preferred embodiment, the interest factor is determined by a body skeleton tracking of said at least person. The body skeleton tracking of said person includes in particular a head pose estimation with the attribute assignment component.

The head pose estimation allows a particularly precise estimation of the attention model. It has been found, that the head pose is the most precise predictor for the interest factor. Other attributes may require larger amounts of computing power for a worse prediction of the interest factor as multiple attributes need to be analyzed.

In a preferred embodiment, the object detection component may be able to detect at least 5, preferably at least 10 or 20 persons. Thereby, the attention model may be determined faster as multiple persons are detected, possibly within the same frame at the same time.

In a preferred embodiment, the first data set comprises a sequence of video frames with three dimensional information, in particular three dimensional cloud points. The movement tracker component of the data processing hardware system determines a trajectory of the at least one person from the sequence of video frames in the field of view. The data processing hardware system updates the attention model based on a number of persons whose trajectory passes through a discretized space of the attention model. Thereby, the attention model may be defined more precisely with a set of video frames. The video frames might be continuously streamed, in particular in real-time.

A further aspect of the invention relates to a computer program product comprising instructions which, when the program is executed by a computer to cause the computer to carry out the method as outlined above.

Another aspect of the invention relates to a computer readable medium comprising instructions, which when executed by a computer, causes the computer to carry out the method as outlined above.

Another aspect of the invention relates to a system, in particular a system for calibrating a recording device. The system comprises a data processing hardware system having an object detection component, an attribute assignment component and a data interface. The data interface is configured to receive a first data set with images and three dimensional information, in particular three dimensional cloud points, generated by a recording device at a first time. The recording device has a field of view. The object detection component of the data processing hardware system is configured to detect at least one person within the field of view in the first data set. The attribute assignment component of the data processing hardware system is configured to determine two or more attributes of the at least one person from the first data set. The attributes include an interest factor for an object and a three dimensional location of the at least one person. The data processing hardware system is configured to generate a descriptor for the at least one person based on the determined attributes of the at least one person. The data processing hardware system is configured to determine based on the descriptor and the attention model a discretized space within the field of view for the object. The attention model is configured to predict a probability of a further person showing interest for the object.

A second aspect of the invention relates to a method for an automatic setup of a multi-camera system. A data processing hardware system receives a first data set. The data set comprises at least one image with information, in particular three dimensional cloud points, from a first camera at a first location. The first camera has a first field of view and a first camera coordinate system. A data interface of the data processing hardware system receives a second data set. The second data set comprises at least one image with information, in particular three dimensional cloud points, from a second camera at a second location. The second camera has a second field of view and a second camera coordinate system. The fields of view of the first and second camera overlap spatially at least partially. The second data set is obtained at the same time as the first data set.

An object detection component of the data processing hardware system detects in the first data set and in the second data set at least one person in the data sets within the respective fields of view of the cameras. The object detection component detects the person in the first data set and in the second data set independently. An attribute assignment component of the data processing hardware system determines at least one attribute of the at least one person the first data set and in the second data set separately. An object matching component of the data processing hardware system matches the detect persons in the first and second data set by comparing the at least one attribute of the persons between the at least one person detected in the first data set and the at least one person detected in the secand data set. The data processing hardware system obtains positional data of the at least one person in the overlapping region from the first and second data set. The data processing hardware system determines one or more coordinate transformation matrixes from the obtained positional data of the matched at least one person. The transformational matrix(es) allow converting the camera coordinate systems into one another.

Additionally the method might include a step of storing the obtained transformation matrix(es) on an electronic memory with the data processing system.

The positional data obtained from the matched person(s) preferably includes at least four points, wherein the four points are not in the same plane. In preferred embodiment, further cloud points of the at least one matched person may be used as positional data. Thereby, the influence of noise and errors may be reduced.

The method allows a simplified calibration method. Previously, multiple camera systems needed to include a point of reference for the calculation of the homomorphic matrixes. This point of reference is typically provided with a specialized reflective cone or manually calculated by the present technical personnel.

The above calibration method allows a determination of the homomorphic matrixes without the need of further specialized tools. The only step necessary is a person walking through the overlapping regions of the fields of view of the cameras. In principle, the above method allows a self-calibrating system. The method may be used in stores to set up systems for tracking customers. Another field of use is to set up camera systems as used in sports to track players (e.g. football).

In a preferred embodiment, the image is an RGB image. The object detection component of the data processing hardware system detects a human skeleton of the at least one person in the RGB image. The data processing hardware system determines the spatial coordinates of the human skeleton with the three dimensional cloud points. The data processing hardware system provides a three dimensional human skeleton for the determination of the one or more transformation matrixes. In an alternative embodiment the image could also be a grayscale image or a black-and-white image.

The detection of the human skeleton may allow the selection of suitable points on the at least one person for calculating the matrix(es).

In a preferred embodiment, the at least one attribute includes at least one of: age, gender, hair color, hairstyle, glasses, skin color, body, height, clothing, posture, social group, facial features and face emotions. In a particularly preferred embodiment, multiple of the attributes are used. Thereby, a matching accuracy may be increased.

In a preferred embodiment, the data processing hardware system receives at least one further data set from the first and/or second camera and/or a further camera wherein the data set comprises a sequence of video frames with three dimensional information including three dimensional cloud points. The object detection component of the data processing hardware system detects in the further data set at least one person within the field of view of the respective camera. The object matching component of the data processing hardware system matches the detected at least one person by comparing the at least one attribute of the person in the further data set with the attributes of the person in the first data set and/or the second data set. The data processing hardware system provides a trajectory of the at least one person by obtaining positional data of the at least one person from the further data set.

Thereby, a movement of at least one person, preferably multiple persons, may be tracked through space and time within the fields of view of the first and second camera. This might be used to calculate the matrix(es). Further, a person may be detected within the first field of view, leave the first field of view, and then enter the second field of view later and be tracked and identified as the same person.

In a preferred embodiment, the data processing hardware system determines a location of at least two persons, preferably at least one or more trajectories, in a single coordinate system with the one or more transformation matrixes. Then, the data processing hardware system generates a heat map based on the at least one trajectory or the locations of the persons. In preferred embodiment, the heat map is generated with multiple trajectories. Thereby, a movement path of the at least one person may be tracked. Further, areas of particular interest can be identified. The trajectories visualize people flow, while a heat map based on locations visualizes a location occupancy. In a preferred embodiment, the first and second data sets comprise a sequence of video frames with three dimensional information, in particular three dimensional cloud points. The data processing hardware system determines a trajectory of the matched at least one person with the data from the first and second camera independently of each other. The data processing hardware system determines the one or more coordinate transformation matrixes with the trajectories of the at least one person determined in the first and second data set. Thereby the precision of the transformation matrixes may be improved.

In a preferred embodiment, the data processing hardware system provides a bird plane parallel to the ground with the trajectory of the at least one person. The trajectory is provided in particular by tracking a neck of the at least one person. The data processing hardware system determines two or more coordinate transformation matrixes that transform the spatial coordinates of each camera into a bird view of the observed fields of view. Thereby, a bird view is automatically provided without any user or other calibration. Bird views may be particularly advantageous for verifying the accuracy of the calculated transformation matrixes by the technical person installing the camera system.

In a preferred embodiment, the data processing hardware system generates a descriptor for the at least one person with the determined attributes of the at least one person. The descriptor is stored in an electronic database. Any electronic memory, e.g. SSD drives or HDD drives, may be suitable. Thereby, recurring visitors may be stored. Further, the database of trajectories and positions may be used to continuously update the homomorphic matrixes to increase a precision of the matrixes.

A further aspect of the invention relates to a computer program product which comprises instructions that when executed by a computer cause the computer to carry out the method as outlined above.

A further aspect of the invention relates to a computer readable medium comprising instructions which, when executed by a computer, cause the computer to carry out the method as outlined above.

A further aspect of the invention relates to a system for calculating one or more transformation matrixes. The system comprises a data processing hardware system with a data interface, an object detection component, an attribute assignment component and an object matching component. The data interface is configured to receive a first data set comprising at least one image with three dimensional information from a first camera at a first location. The camera has a first field of view and a first camera coordinate system. The data interface is further configured to receive a second data set comprising at least one image with three dimensional information from a second camera at a second location. The second camera has a second field of view and a second camera coordinate system.

The first and second data sets are generated at the same time and the first field of view and the second field of view overlap spatially at least partially. The object detection component is configured to detect in the first data set and in the second data set at least one person independently. The attribute assignment component is configured to determine at least one attribute of the at least one person in the first data set and in the second data set independently. The object matching component is configured to match the detected at least one person in the first data set to the detected at least one person in the second data set by comparing the at least one attribute of the detected persons. The at least one attribute of the detected persons is compared between the at least one person detected in the first data set and the at least one person detected in the second data set. The data processing hardware system is further configured to obtain positional data of the matched at least one person in the overlapping region from the first and second data set. The data processing hardware system is configured to determine one or more coordinate transformation matrixes that allow converting the camera coordinate systems into each other from the obtained positional data of the matched at least one person. The system may additionally comprise the first and the second camera.

Non-limiting embodiments of the invention are described, by way of example only, with respect to the accompanying drawings, in which:

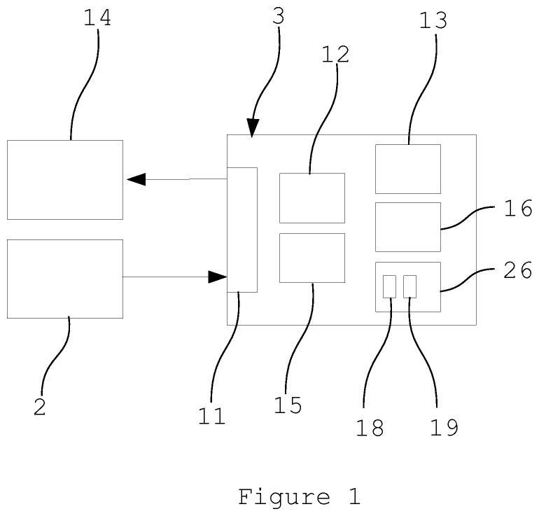

FIG. 1: a schematic drawing of a data processing hardware system according to the invention,

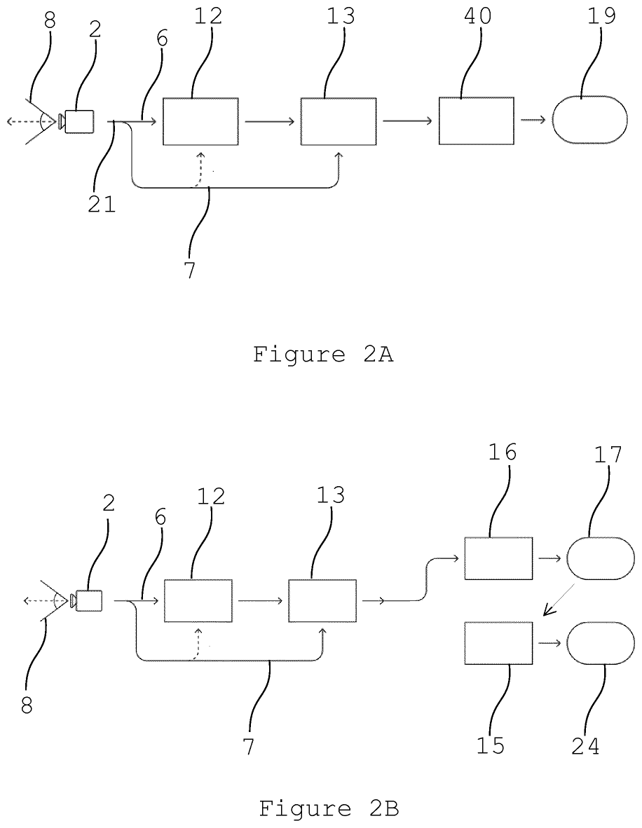

FIG. 2A: a flowchart of a part of a method according to the invention,

FIG. 2B: a flowchart of the method according to the invention,

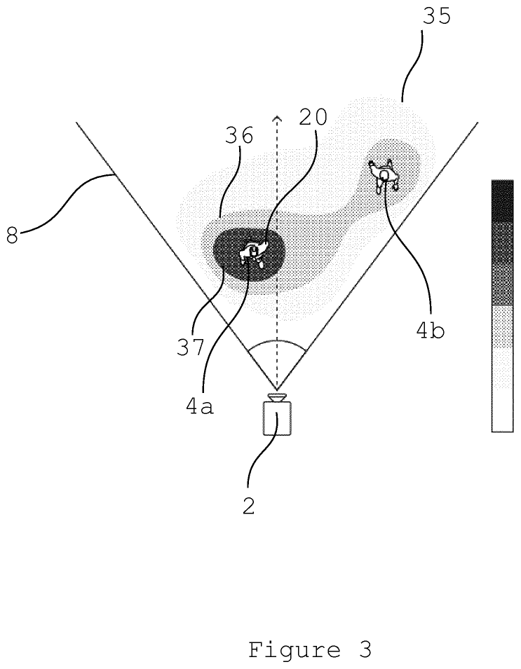

FIG. 3: a top view of a recording device with persons in its field of view and their interest factor,

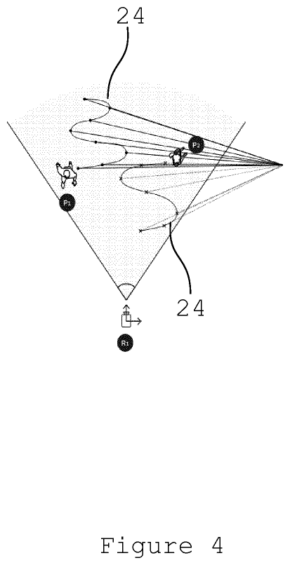

FIG. 4: a top view of a recording device with two persons moving through the field of view,

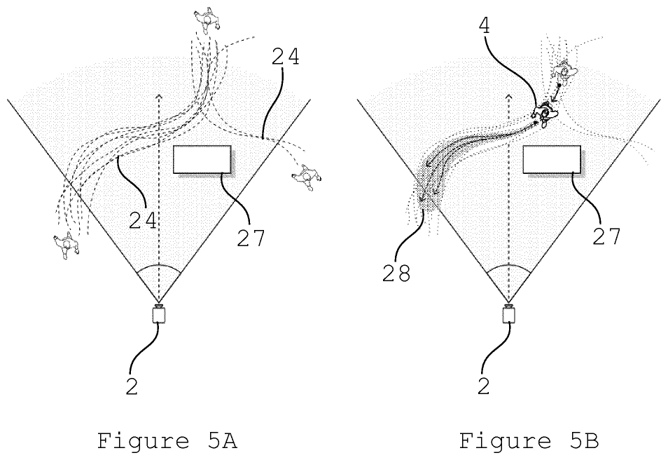

FIGS. 5A and 5B: a further top view of the recording device, wherein an object blocks a trajectory of persons moving through the field of view,

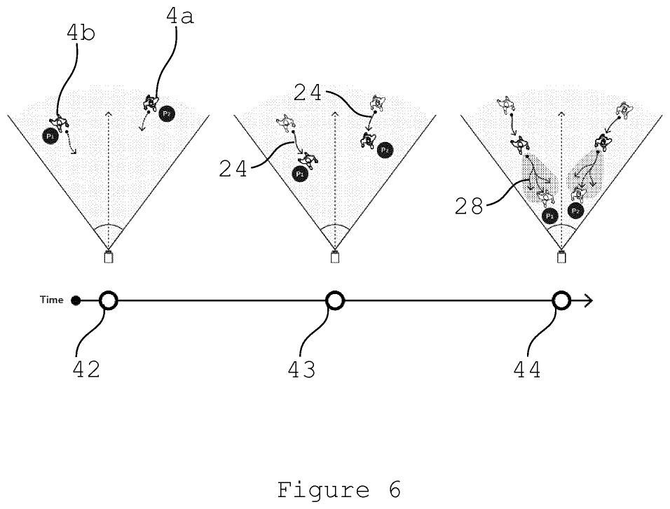

FIG. 6: a series of top views of the recording device through time,

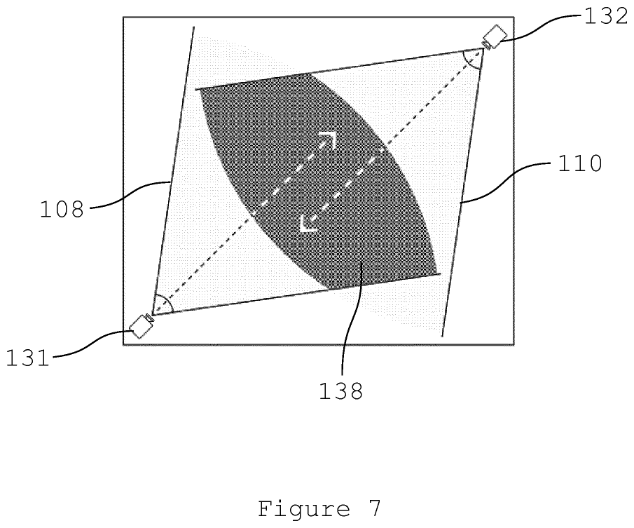

FIG. 7: a top view of two recording devices with their fields of view,

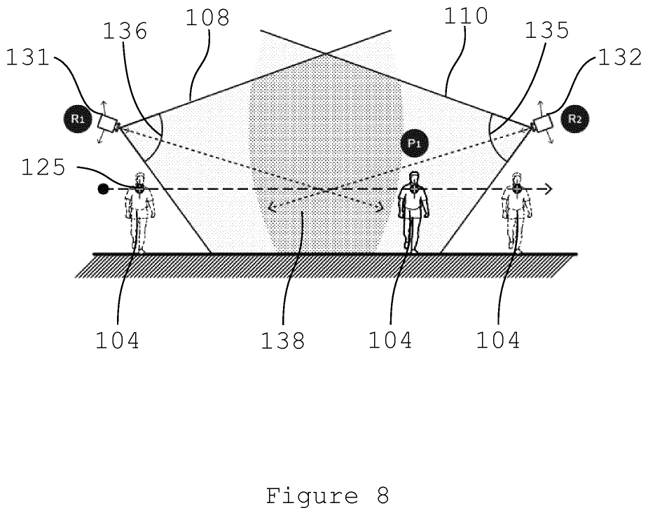

FIG. 8: a side view of the recording devices of FIG. 7,

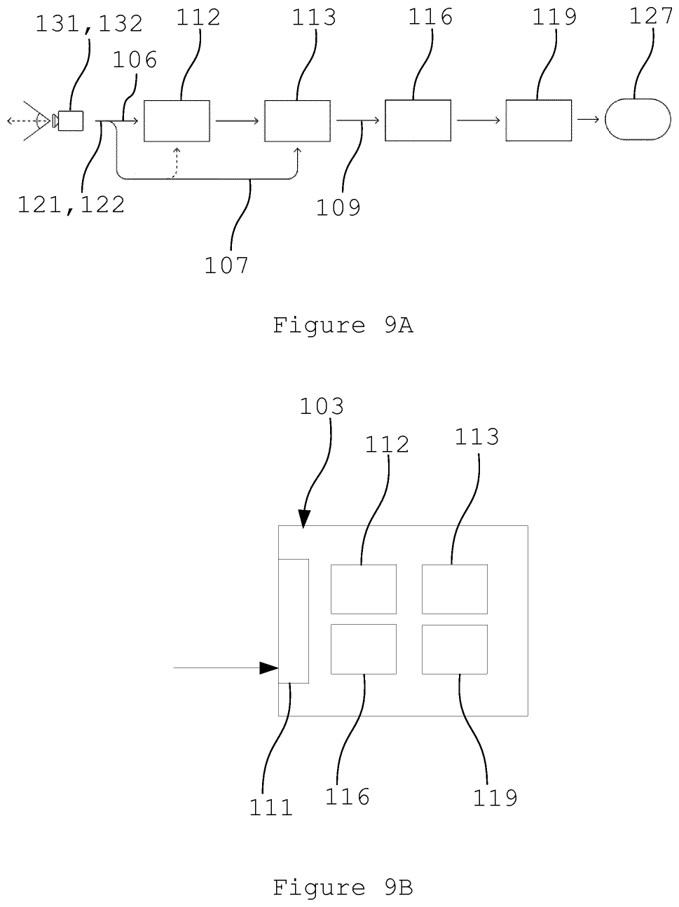

FIG. 9A: a flowchart of a method to determine a transformation matrix,

FIG. 9B: a schematic drawing of another data processing hardware system according to the invention,

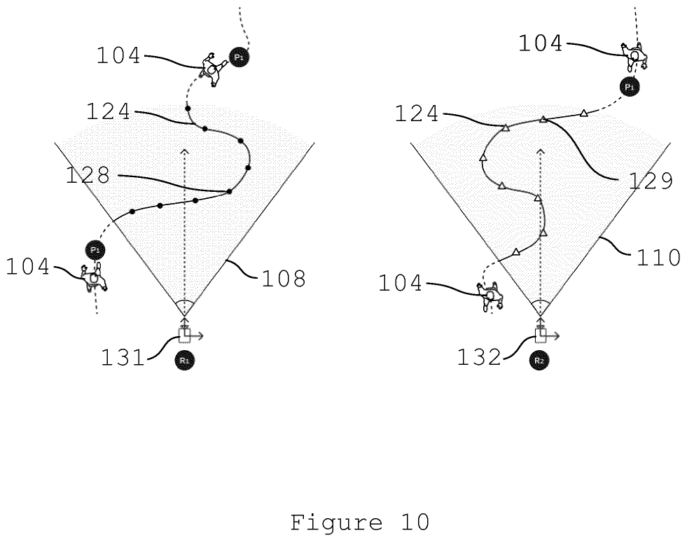

FIG. 10: a top view of the recording devices of FIG. 7 in individualized form,

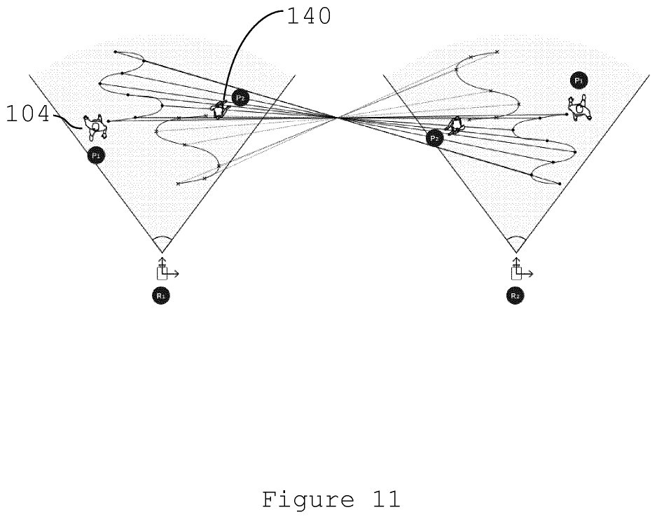

FIG. 11: a second aspect of the recording devices as shown in FIG. 10,

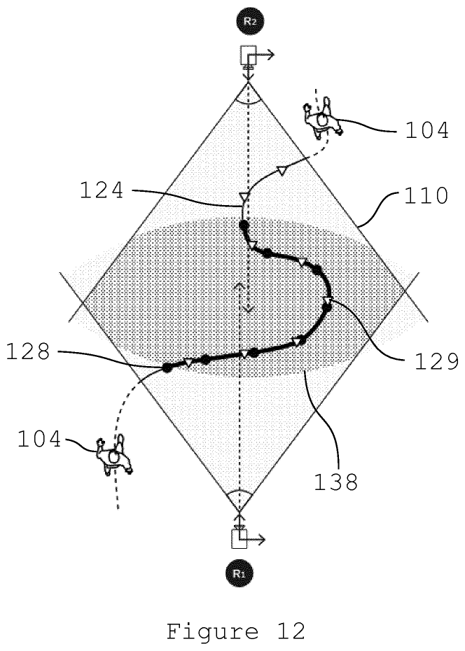

FIG. 12: another top view of the recording devices of FIG. 7, with details regarding a tracking of trajectories,

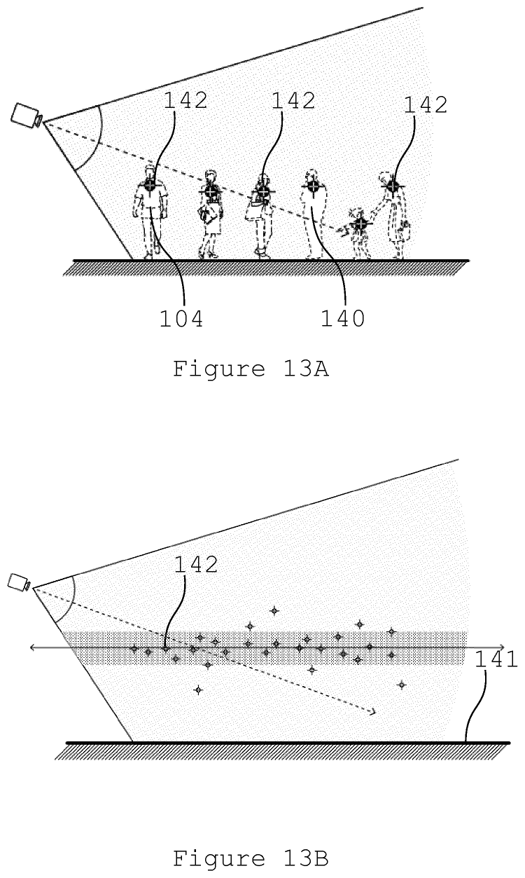

FIGS. 13A and 13B: a side view of a recording device with multiple persons whose neck pose is detected and

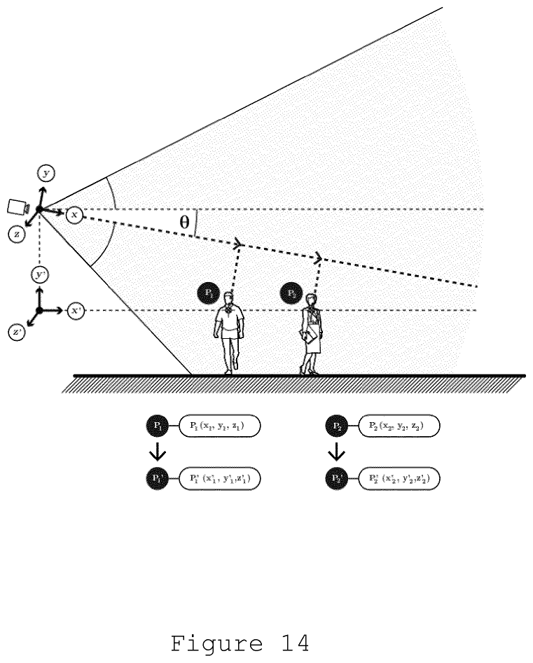

FIG. 14: a coordinate transformation.

FIG. 1 shows a data processing hardware system 3 according to the invention. The data processing hardware system 3 comprises a data interface 11. At the data interface 11, the data processing hardware system 3 can receive information and send information. The data interface 11 is connected wirelessly or with wires to a recording device 2 and receives data sets from the recording device 2. Further, the data interface 11 is connected to a monitor 14. The data processing hardware system 3 sends instructions to the monitor 14 via the data interface 11. The instructions are based on data of the recording device 2.

The recording device 2 is realized as a stereo camera. The stereo camera is adapted to record two RGB images. The three dimensional information is reconstructed with a multiple view geometry algorithm on a processing unit from the two images. The camera may have an integrated processing unit for the reconstruction. The data processing hardware may alternatively reconstruct the three dimensional information. Thereby, three dimensional information realized as three dimensional cloud points of the field of view is obtained. The recorded data is sent as data sets including image data and the recorded three dimensional cloud points to the data interface 11. The data processing hardware system 3 further includes an object detection component 12, an attribute assignment component 13, a movement tracker component 15, an object matching component 16 and an electronic memory 26 for storing an attention model 19 and a motion model 18. With these components, the recording device 2 calculates instructions for the monitor 14 (explained in detail with reference to FIGS. 2A and 2B).

The instructions cause the monitor 14 to play a specific content. The content may be selected from a content library. The content is usually a video which is displayed on the monitor and an audio belonging to the video.

FIG. 2 A shows a flowchart showing a part of the method according to the invention. First, the recording device 2 records an RGB image 6 and three dimensional information 7 realized as three dimensional cloud points. The camera has a field of view 8. The image 6 and the corresponding three dimensional cloud points 7 form a first data set 21 that is forwarded to the data processing hardware system 3. The object detection component 12 of the data processing hardware system 3 detects and identifies an object in the RGB image. For example, if the object includes certain characteristics such as arms ahead and legs, it may be identified as a person. If an object is identified as a person, further attributes are assigned to the person. One of the further attributes is a body skeleton detection. Optionally the object detection component 12 may also use the three dimensional information (dashed line).

The body skeleton detection allows tracking of an orientation of the person. In particular, a head pose and an orientation of the body and the face indicate an interest in a particular object of the person. The head pose might point entirely or partly in the direction of the object. Based on the head pose and three dimensional location of the person it is projected, if the head frontal direction (yaw axis) is towards screen, it is counted as that person has an interest in screen at that particular location and moment. Later on it is calculated for how long the person is showing interest. Depending on this a factor is calculated which expresses the interest of the person in the object. Additionally, the object detection component 12 may detect the eyes and track pupils.

The head pose may be determined by the attribute assignment component. Additionally, body skeleton tracking may determine the head pose as well. The combination of both can improve the accuracy of the determination of the head pose.

The detected person is forwarded to the attribute assignment component 13. The attribute assignment component 13 assigns the current location 20 (see FIG. 3) to the detected person by using the three dimensional cloud points of the detected person 4. Then, the attribute assignment component 13 assigns the determined interest factor for the monitor to the person.

As a result, the data processing hardware system 3 can calculate 40 an attention model 19. The attention model 19 is based on a discretized space of the field of view 8. The data processing hardware system 3 calculates 40 the discretized space 3 and the interest factor assigned to the location 20 (see FIG. 3) in the discretized space. Thereby, an interest factor is assigned to a particular location 20 of the discretized space. Based on this interest factor, it is predicted, whether a future person standing or walking through the location 20 will pay interest to the monitor or not.

This process is repeated, for each person 4 detected in the field of view 8. Thereby, the discretized space of the attention model is filled with interest factors allowing a prediction over the entire field of view. The attention model may be used to calculate areas of different levels of interest.

Such levels of interest are shown in a top view in FIG. 3.

FIG. 3 shows a top view of the recording device 2 (camera) and its field of view 8. Within the field of view, two persons 4a and 4b are located. The person 4a has a head pose pointed directly directed towards a monitor 14 located below the recording device 2 (not shown). Thus, the discretized space of the person 4a (and the discretized spaces around) is assigned a high interest factor in the attention model. The head pose of person 4b does not point directly at the monitor 14 but the field of view of the person 4b includes the monitor 14. Person 4b might thus be able to observe the monitor. However, his interest is lower than the interest of person 4a. Thus, based on the head pose of person 4b, the space is assigned a lower interest factor.

The attention model 19 thus includes discretized spaces 37 with a higher interest factor and discretized spaces 36, 37 with lower interest factors. This is indicated in FIG. 3 by the thickness of the color black over the different areas.

FIGS. 2B and 4 show an advanced determination of the attention model 19. The determination and assignment of attributes is identical to the process shown in FIG. 2A. However, since the recording device 2 delivers a continuous stream of three dimensional cloud points and corresponding RGB images, the attention model 19 may be defined more precisely. In different frames of the received video, the same person may reoccur. This is detected with the object matching component 16. In each frame, the attribute assignment component 13 deduces attributes of the detected objects (i.e. persons). The attribute assignment component 13 assigns current positions as well as the found attributes to the detected persons.

Then, the object matching component 16 compares the attributes between the persons. If sufficient attributes match, the object matching component 16 matches the person and identifies them as a matched person 17 in two different frames. Regularly the matched person 17 will have moved in between the frames. With the different positions provided by the three dimensional cloud points the movement tracker component 15 can determine a trajectory 24 of the person (see FIG. 4).

The trajectories 24 of two persons passing through the field of view are shown in FIG. 4. Person 4a and person 4b are identified and matched at different positions. Thereby, the data processing hardware system 3 can detect the trajectories 24.

FIG. 5A shows a plurality of detected trajectories 24. The trajectories 24 are the result of an obstacle 27 in the movement path of the persons. As a result, most trajectories cross the field of view instead of walking directly towards the recording device 2. These recorded past trajectories can be utilized by the movement tracker component 15 to develop the motion model 19. The motion model 15 predicts the movement of persons within the field of view. For example, if 80% of the trajectories 24 take a certain direction, while 20% turn in another direction, the motion model can provide a probabilistic estimation of the future trajectories 24 of the detected persons. This allows an estimation, where the detected persons are going to be in the future.

FIG. 5B shows a prediction of the walking path of the person 4 walking through the field of view 8. As can be seen in FIG. 5B, the estimation is probabilistic and calculates a multitude of possible paths as well as their likelihood.

FIG. 6 also shows a top view of the recording device 2 and the corresponding field of view 8. The recording device is shown at three different time stages. At point in time in the past 42 two persons 4a and 4b (labeled as “P1” and “P2” in the drawing) enter the field of view. The data processing hardware system 3 detects the two persons 4a and 4b and tracks their trajectories 24 until the present 43. At this point the data processing hardware system 3 calculates a probabilistic estimation of the trajectories 28 in the future 44.

FIGS. 7 to 14 relate to the second aspect of the invention and to the calculation of a coordinate transformation matrix.

FIG. 7 shows a top view of a first recording device 131 and a second recording device 132. The recording devices each have a field of view. The first recording device has a first field of view 108 and the second recording device has a second field of view 110. The fields of view overlap in an overlapping region 138. This can also be seen in the side view of FIG. 7 in FIG. 8. A person 104, which enters the first field of view 108 is detected by a data processing hardware system 103 (see FIG. 9) and tracked through the first field of view 108. As soon as the person 104 enters the second field of view 110 the person 104 is also detected in the data generated by the second camera 132.

Thus, in the overlapping region 138 the person 104 may be detected in the data generated by both recording devices 131 and 132. The recording devices 131, 132 generate RGB image data 106 (see FIG. 9A). Further the recording devices are realized as stereo cameras, which enables them to generate three dimensional information realized as three dimensional cloud points 107 of the respective fields of view 108, 110.

Each camera 131, 132 has its own coordinate system. The recording device 131 or 132 is at the origin of the coordinate system.

Since each camera has an aperture angle 135, 136 and three dimensional information, each camera can determine the coordinates of all cloud points in its coordinate space.

The flowchart shown in FIG. 9A and the data processing hardware system shown in FIG. 9B show how this data is processed in the data processing hardware system 103. The data processing hardware system may be realized as a server. In one embodiment, the data of the recording devices 131, 132 is transferred via a network, such as the Internet, to the server where the calculations according to FIG. 9 are made.

However, it is preferred, that data processing hardware system 103 is realized as a computing module that is installed on-site.

The RGB image data 106 and the three dimensional cloud points 107 are send as data sets from the recording devices 131, 132 to the data processing hardware system 103. The data processing hardware system 103 receives the data sets 121, 122 at an interface 111 and forwards the RGB image data 106 to an object detection component 112. Optionally, the three dimensional cloud points 107 may also be forwarded to the object detection compovent 112. The object detection component 112 detects a person 104 in the image data 106 based on attributes. In particular, the object detection component 112 may identify attributes characteristic for persons, e.g. legs, arms, a torso, a head or similar. Further, the object detection component identifies attributes that are characteristic for a person.

The object and the attributes are then sent to an attribute assignment component 113, where the attributes as well as the current position identified by the three dimensional cloud points 107 belonging to the identified object are assigned to each person. This information is then aggregated in a descriptor 109.

The data processing hardware system 103 receives a data set 121 with RGB image data and three dimensional cloud points from the first recording device 131 and a second data set 122 with RGB image data and three dimensional cloud points from the second recording device 132. Both data sets 121, 122 are analyzed in the way outlined above. The data sets 121 of the first recording device 131 and the data sets 122 of the second recording device 132 are analyzed independently and in each data set objects are detected and persons are identified.

Persons 104 that are located in the overlapping region 138 will be identified in both data sets 121, 122. An object matching component 116 compares the attributes in the descriptors 109 and thereby identifies identical persons in the overlapping region 138. The identification of a person 104 in the overlapping region 138 allows the calculation 119 of a coordinate transformation matrix 127. A plurality (in particular at least 4) of three dimensional cloud points is associated to the person 104. The three dimensional cloud points are determined by the first and the second recording devices 131, 132 independently.

The data processing hardware system 103 determines the position for the detected person in the coordinate system of the first camera 131 and in the coordinate system of the second camera 132.

In a variant, the data processing may obtain the position of one or more body parts in the data sets 121, 122 and use the positions to calculate a coordinate transformation matrix for transposing the coordinates of the first camera coordinate system into the second camera coordinate system.

FIG. 10 shows the same person 104 passing through the first field of view 108 and the second field of view 110 separately. As can be seen in FIG. 10, the recording devices 131, 132 record points 129, 128 along a trajectory 124 of the person. Thereby, the trajectory 124 can be reconstructed for each camera 131, 132 independently. Since the object matching component 116 determined the person to be identical, the trajectories 124 of the at least one person 104 can be matched. This is shown in FIG. 11 for the person 104 and a second person 140. Then, as can be seen from FIG. 12, the trajectories are matched and the trajectory provides a plurality of points which can be used for the calculation of the transformation matrix 127.

This results in the reconstruction of the trajectory through the overlapping area 138 as can be seen from FIG. 12.

Though any body part might be suitable, the three dimensional neck pose 142 is a particularly preferred tracking point for the persons 104 and 140 (see FIGS. 13A and 13B). The neck pose provides the advantage that it stays at a relatively constant height. Thus, if the neck pose is tracked along its way, a plane might be reconstructed from the trajectory that is parallel to the ground 141.

This plane allows transforming the coordinates further into a coordinate system that allows a bird view. Such a coordinate system and its transformation are shown in FIG. 14.

1. A calibration method for a recording device (2), said method including the steps of:
Receiving a first data set (21) with a data interface (11) of a data processing system (3), the data set comprising an image (6) and three dimensional information (7) generated by the recording device (2) at a first point in time, the recording device (2) having a field of view (8);
Detecting with an object detection component (12) of the data processing system (3) in the image at least one person (4) within the field of view (8);
Determining with an attribute assignment component (13) of the data processing system (3) two or more attributes (5) of the at least one person (4) from the first data set (21), wherein the attributes (5) include an interest factor for an object, in particular for a monitor (9), and a three dimensional location (14) of the at least one person (4);
Generating with the data processing system (3) a descriptor (9) for each person based on at least the determined attributes (5) of the at least one person (4);
Calculating an attention model (19) with a discretized space within the field of view (8) based on the descriptor (s) (9) with the data processing system (3), wherein the attention model (19) is configured to predict a probability of a person showing interest for the object.

2-25. (Canceled)
